(19) United States
(12) Patent Application Publication
(10) Pub. No.: US 2022/0081633 A1
(43) Pub. Date: Mar. 17, 2022

(54) PLANT AND PROCESS FOR THE TRANSFORMATION OF BIOMASS

(71) Applicant: HBI S.R.L., Bolzano BZ (IT)

(72) Inventors: Daniele BASSO, Renon BZ (IT); Renato PAVANETTO, Quinto Di Treviso TV (IT)

(21) Appl. No.: 17/309,794

(22) PCT Filed: Dec. 20, 2019
(86) PCT No.: PCT/IB2019/061188

§ 371 Date: Jun. 18, 2021

(30) Foreign Application Priority Data
Dec. 20, 2018 (IT) 102018000020320

(51) Int. Cl. C10L 9/08; C10L 5/44; B09B 3/40

(52) U.S. Cl. CPC C10L 9/086; C10L 5/447; B09B 3/40; C10L 2290/46; C10L 2290/148; C10L 2290/24; C10L 2290/06

(57) ABSTRACT

It refers to a process and a plant for the transformation of biomass into hydrochar.

The present invention refers to a plant and a process for the transformation of biomass into hydrochar. More particularly, it refers to a plant and a process for an efficient transformation of biomass into hydrochar that is an exploitable material for various uses.

As it is known, it is possible to transform biomass into hydrochar that is a solid material with a high content of carbon deriving from the transformation of biomass by a thermochemical process in the presence of pressurized hot water.

The aforementioned material can be usefully exploited in various ways: this material is used, for example, as a solid fuel, a catalyst or a soil conditioner.

Usually, the transformation of biomass into hydrochar occurs in reactors in which a certain quantity of biomass is placed with a water content greater than 60% and/or a sufficient water content to ensure that the biomass is completely immersed in the water. This biomass is brought and maintained at a temperature between 180 and 250° C. and at a pressure higher than the vapor tension of water at those temperatures (therefore, usually between 10 and 50 bar) for a time interval generally but not exclusively between 3 and 8 hours, depending on the chemical characteristics of the biomass.

At the time of the unloading of the so-obtained material, it is necessary to return the system to the ambient temperature, for example through a pressure decrease, with a consequent rapid drop in temperature, precisely from the process temperature to about 100° C., resulting in a partial evaporation of the water.

The main problem of the prior art concerns, therefore, the big energy losses because the energy spent to bring the biomass to the desired temperature inside the reactor is then lost upon unloading.

An object of the present invention is to provide a plant for the transformation of biomass into hydrochar that operates efficiently.

Another object of the invention is to obtain a plant for the transformation of biomass into hydrochar, in which the energy losses are substantially reduced in the unloading phases of the obtained hydrochar.

All said objects and advantages are achieved according to the invention through a process to transform biomass into hydrochar by means of a plant comprising:
a first reactor, a second reactor, a third reactor into which biomass can be loaded from the outside and hydrochar can be unloaded from the plant to the outside;
a fourth reactor, a fifth reactor and a sixth reactor in which the transformation of biomass into hydrochar can take place at a process temperature between 180° C. and 250° C., at a process pressure corresponding or higher than the vapor tension of water at the process temperature, that is between 10 bar and 50 bar, in a time span equal to the reaction time between 3 and 8 hours;
a heat exchanger through which the first reactor, the second reactor, the third reactor are indistinctly connected to the fourth reactor, the fifth reactor and the sixth reactor.

In the plant the first reactor, the second reactor, the third reactor, the fourth reactor, the fifth reactor and the sixth reactor are connected to each other also directly.

In particular, the process according to the invention provides at the initial state that:
the first reactor is full of hydrochar, process water and gas created during the reaction (from now on, these three substances are defined, as a whole, as “process products”) and is pressurized at the process pressure and at an unloading temperature between 30° C. and 50° C.;
the second reactor is full of biomass and water or liquid formed downstream of the process, recirculated partly or totally (from now on, these substances are defined, as a whole, as “feedstock”) and is pressurized at the process pressure;
the third reactor is empty and is pressurized at the process pressure;
the fourth reactor is full of process products, is pressurized at the process pressure and is at a reaction temperature;
the fifth reactor is empty and is pressurized at a process pressure;
the sixth reactor is full of feedstock, is pressurized at the process temperature and is partially heated at a temperature between 160° C. and 210° C.;

The process provides for a first cycle in which, simultaneously:
the first reactor, in succession, is isolated from the rest of the plant, is depressurized at the atmospheric pressure, is emptied of the process products contained in it, is loaded with feedstock, and is, finally, pressurized at the process pressure;
the process products contained in the fourth reactor are transferred into the third reactor passing through the heat exchanger in countercurrent with the feedstock passing through the heat exchanger which is transferred from the second reactor to the fifth reactor, so as to transfer heat from the process products to the feedstock;
the air contained in the third reactor and the fifth reactor is transferred into the second reactor and the fourth reactor, respectively;
in the sixth reactor, the feedstock is brought to the reaction temperature, in which the reaction as well as the transformation into hydrochar and in the other process products take place.

Advantageously, the process according to the invention, may provide that at the end of the first cycle, a second cycle is performed in which, simultaneously, the operation of the first reactor during the first cycle is performed by the third reactor, the operation of the second reactor during the first cycle is performed by the first reactor, the operation of the third reactor during the first cycle is performed by the second reactor, the operation of the fourth reactor during the first cycle is performed by the sixth reactor, the operation of the fifth reactor during the first cycle is performed by the fourth reactor and the operation of the sixth reactor during the first cycle is performed by the fifth reactor.

Besides, the process according to the invention may provide that at the end of the second cycle, a third cycle is performed in which, simultaneously, the operation of the first reactor during the first cycle is performed by the second reactor, the operation of the second reactor during the first cycle is performed by the third reactor, the operation of the third reactor during the first cycle is performed by the first reactor, the operation of the fourth reactor during the first cycle is performed by the fifth reactor, the operation of the fifth reactor during the first cycle is performed by the sixth reactor and the operation of the sixth reactor during the first cycle is performed by the fourth reactor.

Through the process according to the invention it is possible to obtain hydrochar and the other process products more efficiently than in the prior art.

This efficiency is obtained by decoupling the three characteristic times of the thermochemical process of transformation of biomass in the presence of pressurized hot water, namely:
1. the feeding time of the feedstock and unloading of the process products (time 1);
2. the process time (generally but not exclusively 3 to 8 hours) (time 2);
3. the heat exchange time between incoming feedstock and outgoing process products (time 3).

In fact, with the process according to the invention it is possible to ensure a continuous operation of the plant, in terms of feeding and unloading (time 1), regardless of the process time (time 2) and regardless of the time it takes for the heat exchanger to complete a heat exchange in countercurrent (time 3).

Accordingly, the high heat exchange efficiencies obtainable by decoupling the heat exchange time (time 3) from the other two characteristic times of the system involve a clear reduction in operating costs directly related to the supply of thermal energy necessary for bringing, at each cycle, the feedstock from the ambient temperature to the process temperature.

In this way, the heat exchanger has all the time necessary for a complete heat exchange (time 3), not affecting minimally neither the reaction time (time 2), nor the loading/unloading time (time 1).

In comparison with the conventional present technical solutions implementing the thermochemical process for the transformation of biomass, the process according to the invention allows to obtain much more advantageous operating costs and less waste of energy.

Advantageously, in the process according to the invention, the changes in level within the plant can be managed by means of an expansion vessel.

The objects and advantages of the invention are also achieved by means of a plant to transform biomass into hydrochar, comprising:
a first reactor, a second reactor, a third reactor into which feedstock can be loaded from the outside and the process products can be unloaded from the plant to the outside;
a fourth reactor, a fifth reactor and a sixth reactor in which the transformation of biomass into process products can take place at a process temperature between 180° C. and 250° C., at a process pressure corresponding or higher than the vapor tension of the water at the process temperature, that is between 10 bar and 50 bar, in a time span equal to the reaction time, generally but not exclusively between 3 and 8 hours;
a heat exchanger through which the first reactor, the second reactor, the third reactor are indistinctly connected to the fourth reactor, the fifth reactor and the sixth reactor;
   the first reactor, the second reactor, the third reactor, the fourth reactor, the fifth reactor and the sixth reactor being connected also directly to one another.

Besides, the plant according to the invention may include a loading/unloading pump, suitable for loading feedstock or unloading the process products into/from at least one of the first reactor, the second reactor, the third reactor, the fourth reactor, the fifth reactor and the sixth reactor.

Advantageously, a feed pump may be included, suitable for performing the pressurization in at least one of the first reactor, the second reactor, the third reactor, the fourth reactor, the fifth reactor and the sixth reactor.

Besides, in the plant according to the invention an expansion vessel may be included, suitable for managing the level changes within the plant.

Advantageously, at least one of the first reactor, the second reactor, the third reactor may be a tank, so as to reduce the costs of the entire plant.

Further features and details of the invention can be better understood from the following specification that is supplied by way of a non-limiting example as well as from the annexed drawings, wherein:

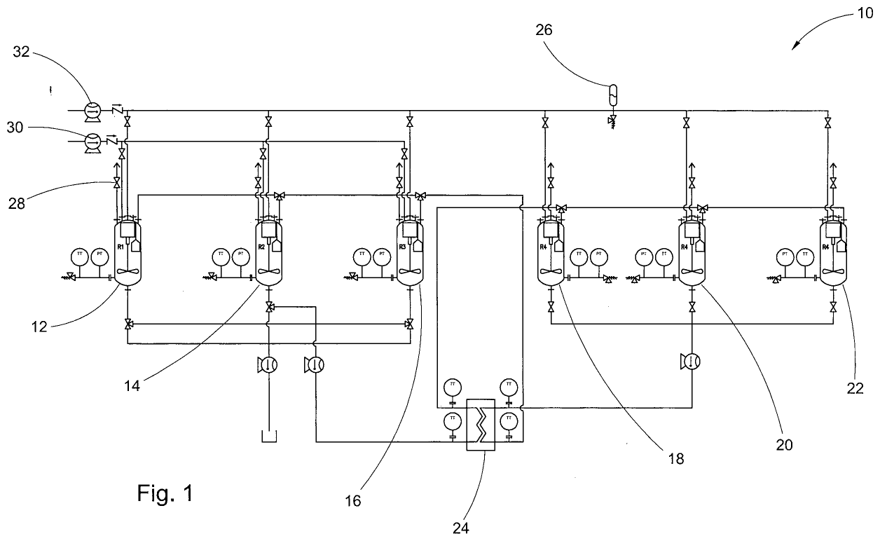

FIG. 1 is a schematic view of a plant for the transformation of biomass into hydrochar, the plant being made according to the invention;

FIG. 2 is a diagram illustrating the operation of the plant in FIG. 1;

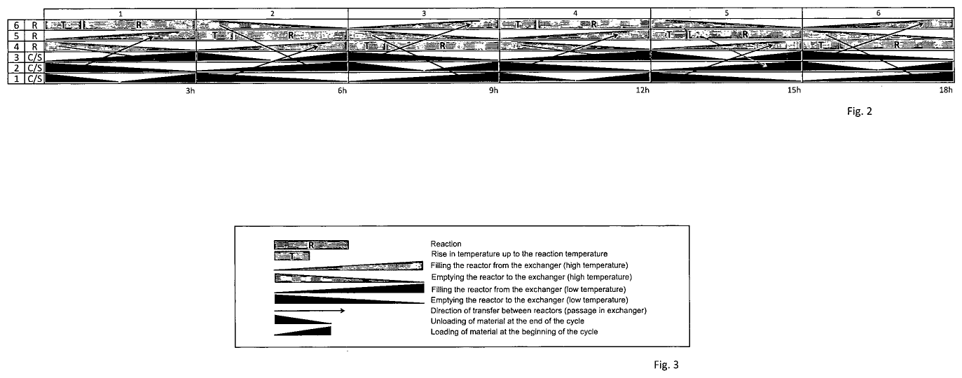

FIG. 3 is a summary caption that explains the signs present in the diagram in FIG. 2.

With reference to the attached figures, reference number 10 denotes a plant for the transformation of biomass into hydrochar.

The plant 10 according to the invention includes six reactors 12, 14, 16, 18, 20, 22 which have the same capacity and are connected to one another and to a heat exchanger 24 as well as to a gas (air) expansion vessel 26.

Specifically, the plant 10 includes a first reactor 12, a second reactor 14 and a third reactor 16 in which the loading and unloading of feedstock and process products take place between the plant and the outside, respectively, as well as a fourth reactor 18, a fifth reactor 20 and a sixth reactor 22 in which the reaction takes place, that is the transformation of feedstock into process products.

In the fourth reactor 18, the fifth reactor 20 and the sixth reactor 22, the reaction conditions of the material are the same as those provided by the prior art, in which the production does not take place in continuous mode, that is the temperature is 220° C., the pressure is 20 bar and the reaction time is about 3 hours.

Of course, the process temperature can be different from 220° C., that is, the temperature can be between 180° C. and 250° C., the pressure can be different from 20 bar, but in any case it has to correspond with or be higher than the vapor tension of the water at the process temperature, and the time may be longer than 3 hours.

The heat exchanger 24 operates in counter-current and with high efficiency.

The entire plant 10, that is, all the six reactors 12, 14, 16, 18, 20, 22 and the heat exchanger 24, are always kept at the reaction pressure, that is, a pressure of 20 bar.

Any variations in level are managed by means of the gas (air) expansion vessel 26.

The loading and unloading of the material, feedstock and process products are performed at atmospheric pressure, isolating the single reactor, specifically the first reactor 12, the second reactor 14 and the third reactor 16 which according to the present embodiment mode, are the reactors responsible for loading and unloading the materials.

The re-pressurization is carried out individually via a feed pump 32 in the absence of gas (air), thus compressing only the fluid.

In general terms, the operating procedure of the plant 10 provides a series of continuous cycles and each cycle lasts 3 hours.

However, the reaction time can be different from 3 hours and is determined according to the type of feedstock and/or the chemical-physical characteristics of the process products to be obtained, that is generally but not exclusively 3 to 8 hours.

In one of the last three reactors, and specifically by rotation the fourth reactor 18, the fifth reactor 20 and the sixth reactor 22, the reaction of transformation of the biomass into hydrochar takes place.

In particular, in each of the reactors 18, 20, 22 in which the reaction and the consequent transformation of the biomass into hydrochar take place by rotation, in a first phase of the cycle, in a limited time, the material is brought to the nominal temperature, that is to 220° C., the material being exiting the heat exchanger 24, and subsequently the reaction takes place.

In one of the first three reactors, and specifically by rotation the first reactor 12, the second reactor 14 and the third reactor 16, material is unloaded and loaded with the outside, specifically the feedstock is loaded and the process products are unloaded.

In particular, each of the reactors 12, 14, 16 in which the unloading and loading takes place by rotation, is first isolated from the rest of the plant 10 and its internal pressure is lowered until it is equal to the atmospheric pressure. First, the reactor is unloaded of the process products and subsequently is loaded with feedstock. The loaded material is brought to the nominal reaction pressure, that is to 20 bar, and finally, the reactor in question is brought back into communication with the rest of the plant 10.

The remaining four reactors perform the heat exchange with the transfer of heat by the mixture composed of the process products, at the end of the reaction, that is at the end of the cycle, towards the incoming feedstock, that is at the beginning of the cycle. The reactors are emptied and filled two by two through a transfer of material in equi-pressure, that is the nominal reaction pressure of 20 bar.

Now, the operation of the plant 10 in the first cycle is described in detail with reference to FIGS. 2 and 3.

In the initial state of the first cycle, the first reactor 12 is full of process products ready to be unloaded, and is pressurized. In other words, the first reactor 12 is loaded with process products at a temperature of 40° C. and a pressure of 20 bar.

The second reactor 14 is full of feedstock, and is pressurized and is therefore at the pressure of 20 bar.

The third reactor 16 is empty and pressurized and is therefore at the pressure of 20 bar.

The fourth reactor 18 is full of process products at the end of the reaction and is therefore at a temperature of 220° C. and a pressure of 20 bar.

The fifth reactor 20 is empty and pressurized and is therefore at the pressure of 20 bar.

The sixth reactor 22 is full of feedstock, partially heated, to a temperature of about 200° C., and pressurized and is therefore at a pressure of 20 bar.

Within the first cycle, the following operations take place.

The process products contained in the fourth reactor 18 are passed inside the heat exchanger 24 in counter-current to transfer the heat to the feedstock contained in the second reactor 14; in this way, the process products are transferred to the third reactor 16 and the feedstock is transferred to the fifth reactor 20.

The pressure inside the five reactors 14, 16, 18, 20, 22 (that is all reactors except the first reactor 12) is kept constant, that is at 20 bar, the six reactors being connected in parallel.

The air contained in the third reactor 16 and the fifth reactor 20 that were previously empty is discharged into the second reactor 14 and fourth reactor 18, respectively, which were emptied of the respective material.

The reaction of the feedstock takes place in the sixth reactor 22; in other words, the feedstock, which is heated partially initially, is brought to the reaction temperature, that is to 220° C.

The unloading and loading of material takes place in the first reactor 12. Precisely, the first reactor 12 is isolated from the rest of the plant 10 and subsequently depressurized to atmospheric pressure through a first valve 28. The process products are unloaded from the first reactor 12 at atmospheric pressure through a first loading/unloading pump 30. The estimated time required for the unloading operations is equal to approximately half of the cycle time that is about 1.5 hours.

Subsequently, the feedstock is loaded at atmospheric pressure into the same first reactor 12 by means of the first loading/unloading pump 30. The estimated time required for the loading operations is equal to approximately half of the cycle time that is about 1.5 hours.

Then, the first reactor 12 is pressurized at the nominal pressure of the plant 10, that is to 20 bar, by means of the feed pump 32.

Finally, the first reactor 12 is reconnected to the plant 10.

At the end of the first cycle, the first reactor 12 is full of material to transform, that is feedstock, and is pressurized at the nominal pressure of the plant, that is 20 bar.

The second reactor 14 is empty and pressurized at the nominal pressure of the plant.

The third reactor 16 is full of process products ready to be unloaded and is pressurized. In particular, the hydrochar in the third reactor 16 is at a temperature of 40° C. and a pressure of 20 bar.

The fourth reactor 18 is full of initial feedstock, partially heated at a temperature of 200° C. and is pressurized at the nominal value, that is 20 bar.

The fifth reactor 20 is empty and pressurized at the nominal pressure of the plant.

The sixth reactor 22 is full of process products and is pressurized at the nominal pressure value.

Subsequently, the second cycle proceeds with material displacements and transformations similar to those described above but with operation of different reactors.

In the second cycle, concerning the first three reactors 12, 14, 16 in which the unloading and loading of material takes place, the operation of the first reactor 12 is performed by the third reactor 16, the operation of the second reactor 14 is performed by the first reactor 12 and the operation of the third reactor 16 is performed by the second reactor 14.

Concerning the second three reactors 18, 20, 22 in which the reaction with transformation of biomass into hydrochar takes place, the operation of the fourth reactor 18 is performed by the sixth reactor 22, the operation of the fifth reactor 20 is performed by the fourth reactor 18 and the operation of the sixth reactor 22 is performed by the fifth reactor 20.

In the third cycle, concerning the first three reactors 12, 14, 16 in which the unloading and loading of material takes place, the operation in the first cycle of the first reactor 12 is performed by the second reactor 14, the operation in the first cycle of the second reactor 14 is performed by the third reactor 16 and the operation in the first cycle of the third reactor 16 is performed by the first reactor 12.

Concerning the second three reactors 18, 20, 22 in which the reaction with transformation of biomass into hydrochar takes place, the operation in the first cycle of the fourth reactor 18 is performed by the fifth reactor 20, the operation in the first cycle of the fifth reactor 20 is performed by the sixth reactor 22 and the operation in the first cycle of the sixth reactor 22 is performed by the fourth reactor 18.

The cycle following the third cycle is the same as the first cycle previously described.

The capacity of the reactors can be changed according to the requirements, also according to the total number of the reactors. In particular, by increasing the number of reactors it is possible to:
increase the productivity for the same heat exchange time (time 3), while maintaining the same capacity of the reactors; or
decrease the capacity of the reactors, while maintaining the same productivity.

Besides, variants can be provided which are to be considered as included in the scope of the invention as defined by the following claims. For example, it is possible to add a compressor to restore the pressure of the expansion vessel, in case of pressure loss.

Moreover, depending on the moisture content of the biomass, it may be necessary to add water or recirculate partially or totally the liquid formed downstream of the process.

According to a variant of the invention, the first reactor 12, the second reactor 14 and the third reactor 16 as previously described can be replaced by tanks with consequent cost savings.

In that case, the expulsion of the process products, transferred from the reactor to the tank through the exchanger, takes place by exploiting the pressure drop between the reactor and the atmosphere, passing the process products through a suitable diaphragm.

Besides, it is necessary to activate the compressor to maintain the nominal pressure throughout the cycle time as the pressure is discharged in the passage through the diaphragm.

1. A process to transform biomass into hydrochar by means of a plant (10) comprising:
a first reactor (12), a second reactor (14), a third reactor (16) into which feedstock can be loaded from the outside and the process products can be unloaded from the plant (10) to the outside;
a fourth reactor (18), a fifth reactor (20) and a sixth reactor (22) in which the transformation of biomass into hydrochar can take place at a process temperature between 180° C. and 250° C., at a process pressure corresponding or higher than the vapor tension of water at the process temperature, namely between 15 bar and 30 bar, in a time span equal to the reaction time between 3 and 8 hours;
a heat exchanger (24) through which the first reactor (12), the second reactor (14), the third reactor (16) are indistinctly connected to the fourth reactor (18), the fifth reactor (20) and the sixth reactor (22);
the first reactor (12), the second reactor (14), the third reactor (16), the fourth reactor (18), the fifth reactor (20) and the sixth reactor (22) being connected to one another also directly;
the process providing at the initial state that:
the first reactor (12) is full of process products, is pressurized at the process pressure and at an unloading temperature between 30° C. and 50° C.;
the second reactor (14) is full of feedstock and is pressurized at the process pressure;
the third reactor (16) is empty and is pressurized at the process pressure;
the fourth reactor (18) is full of process products, is pressurized at the process pressure and is at a reaction temperature;
the fifth reactor (20) is empty and is pressurized at a process pressure;
the sixth reactor (22) is full of feedstock, is pressurized at the process temperature and is partially heated at a temperature between 160° C. and 210° C.;
the process providing a first cycle in which, simultaneously:
the first reactor (12), in succession, is isolated from the rest of the plant (10), is depressurized at the atmospheric pressure, is emptied of the process products contained in it, is loaded with feedstock, and is, finally, pressurized at the process pressure;
the process products contained in the fourth reactor (18) are transferred into the third reactor (16) passing through the heat exchanger (24) in countercurrent with the feedstock passing through the heat exchanger (24) which is transferred from the second reactor (14) to the fifth reactor (20), so as to transfer heat from the process products to the feedstock;
the air contained in the third reactor (16) and the fifth reactor (20) is transferred into the second reactor (14) and the fourth reactor (18), respectively;
in the sixth reactor (22), the feedstock is brought to the reaction temperature, and the reaction as well as the transformation into process products take place.

2. The process according to claim 1 wherein at the end of the first cycle, a second cycle is performed in which, simultaneously, the operation of the first reactor (12) during the first cycle is performed by the third reactor (16), the operation of the second reactor (14) during the first cycle is performed by the first reactor (12), the operation of the third reactor (16) during the first cycle is performed by the second reactor (14), the operation of the fourth reactor (18) during the first cycle is performed by the sixth reactor (22), the operation of the fifth reactor (20) during the first cycle is performed by the fourth reactor (18) and the operation of the sixth reactor (22) during the first cycle is performed by the fifth reactor (20).

3. The process according to claim 2 wherein at the end of the second cycle, a third cycle is performed in which, simultaneously, the operation of the first reactor (12) during the first cycle is performed by the second reactor (14), the operation of the second reactor (14) during the first cycle is performed by the third reactor (16), the operation of the third reactor (16) during the first cycle is performed by the first reactor (12), the operation of the fourth reactor (18) during the first cycle is performed by the fifth reactor (20), the operation of the fifth reactor (20) during the first cycle is performed by the sixth reactor (22) and the operation of the sixth reactor (22) during the first cycle is performed by the fourth reactor (18).

4. The process according to claim 1, wherein the changes in level within the plant are managed by means of an expansion vessel (26).

5. The process according to claim 1, wherein water is added to the biomass, or liquid formed downstream of the process is re-circulated partially or totally in the biomass.

6. A plant (10) to transform biomass into hydrochar, comprising:
a first reactor (12), a second reactor (14), a third reactor (16) into which feedstock can be loaded from the outside and the process products can be unloaded from the plant (10) to the outside;
a fourth reactor (18), a fifth reactor (20) and a sixth reactor (22) in which the transformation of biomass into hydrochar can take place at a process temperature between 180° C. and 250° C., at a process pressure corresponding or higher than the vapor tension of water at the process temperature, namely between 10 bar and 50 bar, in a time span equal to the reaction time between 3 and 8 hours;
a heat exchanger (24) through which the first reactor (12), the second reactor (14), the third reactor (16) are indistinctly connected to the fourth reactor (18), the fifth reactor (20) and the sixth reactor (22);
the first reactor (12), the second reactor (14), the third reactor (16), the fourth reactor (18), the fifth reactor (20) and the sixth reactor (22) being connected also directly to one another.

7. The plant (10) according to claim 6, wherein a loading/unloading pump (30) is comprised and is adapted to load feedstock or unload the process products into/from at least one of the first reactor (12), the second reactor (14), the third reactor (16), the fourth reactor (18), the fifth reactor (20) and the sixth reactor (22).

8. The plant (10) according to claim 6, wherein a feed pump (32) is comprised and is adapted to perform the pressurization in at least one of the first reactor (12), the second reactor (14), the third reactor (16), the fourth reactor (18), the fifth reactor (20) and the sixth reactor (22).

9. The plant (10) according to one of the preceding claim 6, wherein an expansion vessel (26) is comprised and is adapted to manage level changes within the plant.

10. The plant (10) according to claim 5, wherein at least one of the first reactor (12), the second reactor (14), the third reactor (16) is a tank.

11. The process according to claim 2, wherein the changes in level within the plant are managed by means of an expansion vessel (26).

12. The process according to claim 2, wherein water is added to the biomass, or liquid formed downstream of the process is re-circulated partially or totally in the biomass.

13. The process according to claim 3, wherein the changes in level within the plant are managed by means of an expansion vessel (26).

14. The process according to claim 3, wherein water is added to the biomass, or liquid formed downstream of the process is re-circulated partially or totally in the biomass.

15. The process according to claim 5, wherein water is added to the biomass, or liquid formed downstream of the process is re-circulated partially or totally in the biomass.
